(19) United States
(12) Patent Application Publication
(10) Pub. No.: US 2020/0380905 A1
(43) Pub. Date: Dec. 3, 2020

(54) Method for controlling a multi-screen splicing structure having display devices capable of displaying specific patterns when detecting proximity of another display

(71) Applicants: BenQ Intelligent Technology (Shanghai) Co., Ltd, Shanghai (CN); BENQ CORPORATION, Taipei (TW)

(72) Inventors: Chin-Jui Chi, Taoyuan City (TW); Pei-Wen Huang, Taipei City (TW); Ta-Wei Liu, Taoyuan City (TW)

(21) Appl. No.: 16/853,686

(22) Filed: Apr. 20, 2020

(30) Foreign Application Priority Data
May 29, 2019 (CN) 201910454639.X

(51) Int. Cl. G09G 3/20; G06F 3/14

(52) U.S. Cl. CPC G09G 3/20; G06F 3/1446; G09G 2300/026; G09G 2370/16; G09G 2360/06; G09G 2356/00; G09G 2360/04

(57) ABSTRACT

A multi-screen splicing structure has a plurality of display devices. Each display device has a display panel, a sensing module, and a control circuit. When the sensing module of a display device senses the sensing module of another display device, the control circuit determines which side of the display panel is adjacent to the proximate display device according to the sensing states of a plurality of sensors of the sensing module. The control circuit controls a portion of pixels adjacent to the proximate display device to display a pattern.

### BACKGROUND OF THE INVENTION

### 1. Field of the Invention

The present invention relates to a method for controlling a multi-screen splicing structure, and more particularly to a method for controlling a plurality of display devices of a multi-screen splicing structure to display patterns when detecting proximity of another display.

### 2. Description of the Prior Art

Display devices have been widely used in modern society to display images and information. With the increasing number of display devices, how to splice multiple display devices together to form a larger multi-screen splicing structure to display a larger image and present more information is currently an important topic in the industry.

### SUMMARY OF THE INVENTION

An embodiment of the present invention discloses a method for controlling a multi-screen splicing structure. The multi-screen splicing structure comprises a first display device and a second display device. The first display device comprises a first display panel, a first sensing module and a first control circuit. The first display panel comprises a plurality of first pixels. The first sensing module comprises a plurality of first sensors respectively disposed around the first display panel. The first control circuit is coupled to the first display panel and the first sensing module. The second display panel comprises a plurality of second pixels. The second sensing module comprises a plurality of second sensors respectively disposed around the second display panel. The second control circuit is coupled to the second display panel and the second sensing module. The method comprises when the first sensing module senses the second sensing module, the first control circuit determining that a first side of the first display panel is adjacent to the second display device and controlling a first portion of the first pixels adjacent to the first side to display a first pattern; and when the second sensing module senses the first sensing module, the second control circuit determining that a second side of the second display panel is adjacent to the first display device and controlling a second portion of the second pixels adjacent to the second side to display a second pattern.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a multi-screen splicing structure according to an embodiment of the present invention.

FIG. 2 is a schematic diagram of a first display device and a second display device of the multi-screen splicing structure in FIG. 1.

FIG. 3 is a flowchart of a method for controlling the multi-screen splicing structure in FIG. 1 according to an embodiment of the invention.

FIGS. 4 to 8 are other schematic diagrams of the multi-screen splicing structure in FIG. 1, respectively.

FIG. 9 is a functional block diagram of a multi-screen splicing structure according to another embodiment of the present invention.

FIGS. 10 to 12 are schematic diagrams of the multi-screen splicing structure in FIG. 9.

### DETAILED DESCRIPTION

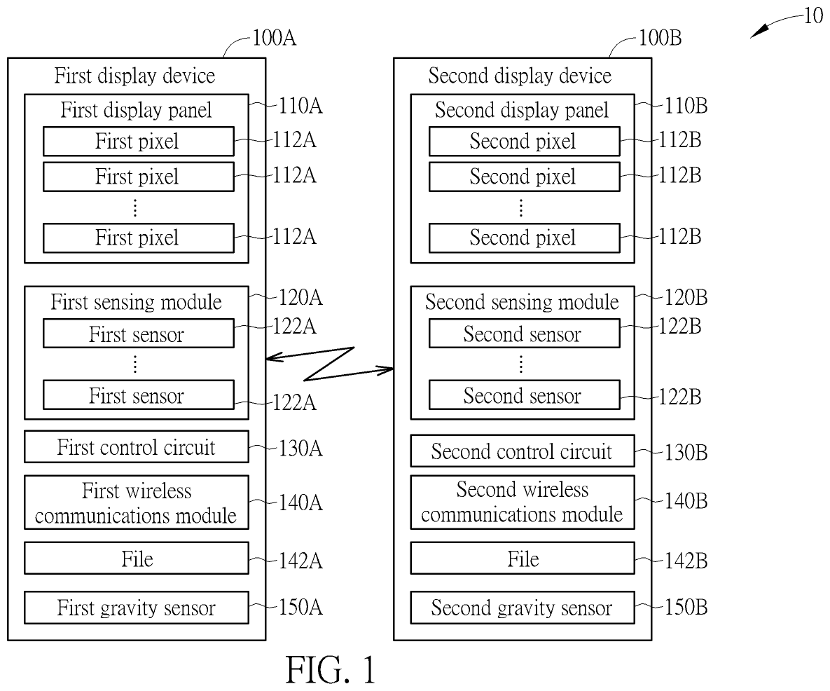

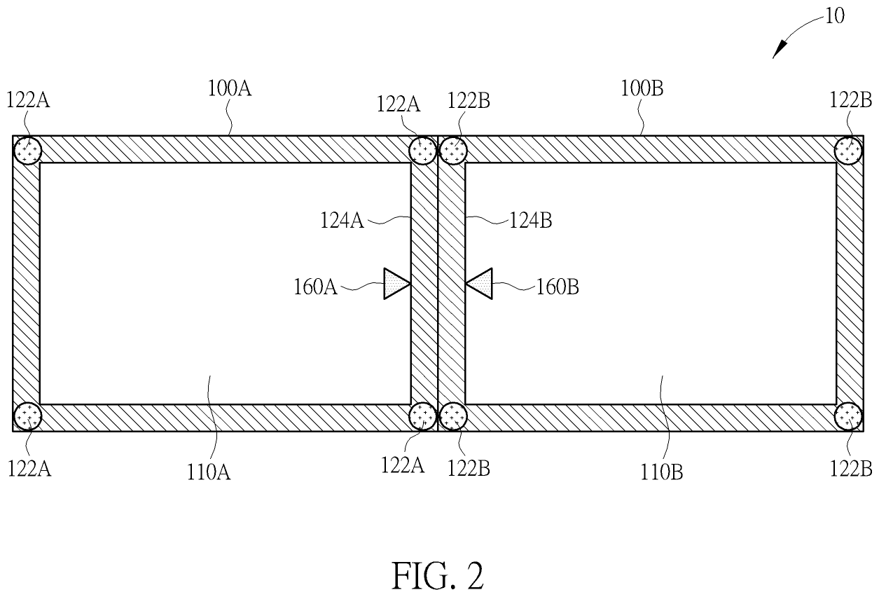

FIG. 1 is a functional block diagram of a multi-screen splicing structure 10 according to an embodiment of the present invention, and FIG. 2 is a schematic diagram of a first display device 100A and a second display device 100B of the multi-screen splicing structure 10 in FIG. 1. The multi-screen splicing structure 10 comprises a first display device 100A and a second display device 10B. The first display device 100A comprises a first display panel 110A, a first sensing module 120A, and a first control circuit 130A. The first display panel 110A comprises a plurality of first pixels 112A for displaying images. The first sensing module 120A comprises a plurality of first sensors 122A, which are respectively disposed around the first display panel 110A. Taking FIG. 2 as an example, the first sensing module 120A comprises four first sensors 122A, which are respectively disposed at four corners of the first display panel 110A. The first control circuit 130A is coupled to the first display panel 110A and the first sensing module 120A, and is configured to control the operations of the first display device 100A. The first control circuit 130A is capable of determining which side of the first display panel 110A is adjacent to the second display 100B according to the sensing states of the first sensors 122A. Similarly, the second display device 100B comprises a second display panel 110B, a second sensing module 120B, and a second control circuit 130B. The second display panel 110B comprises a plurality of second pixels 112B for displaying images. The second sensing module 120B comprises a plurality of second sensors 122B, which are respectively disposed around the second display panel 110B. The second sensors 122B can mutually sense with the plurality of first sensors 122A of the first sensing module 120A. Taking FIG. 2 as an example, the second sensing module 120B comprises four second sensors 122B, which are respectively arranged at four corners of the second display panel 110B, and are configured to mutually sense with the first sensors 122A. The second control circuit 130B is coupled to the second display panel 110B and the second sensing module 120B, and is configured to control the operations of the second display device 100B. The second control circuit 130B is capable of determining which side of the second display panel 110B is adjacent to the first display 100A according to the sensing states of the second sensors 122B.

When the first sensing module 120A senses the second sensing module 120B, the first control circuit 130A determines that the first side 124A of the first display panel 110A is adjacent to the second display device 110B according to the sensing states of the first sensors 122A, and controls a first portion of the first pixels 112A adjacent to the first side 124A to display a first pattern 160A. Similarly, when the second sensing module 120B senses the first sensing module 120A, the second control circuit 130B determines that the second side 124B of the second display panel 110B is adjacent to the first display device 100A according to the sensing states of the second sensors 122B, and controls a second portion of the second pixels 112B adjacent to the second side 124B to display a second pattern 160B. In this embodiment, the first pattern 160A and the second pattern 160B are symmetrical to each other.

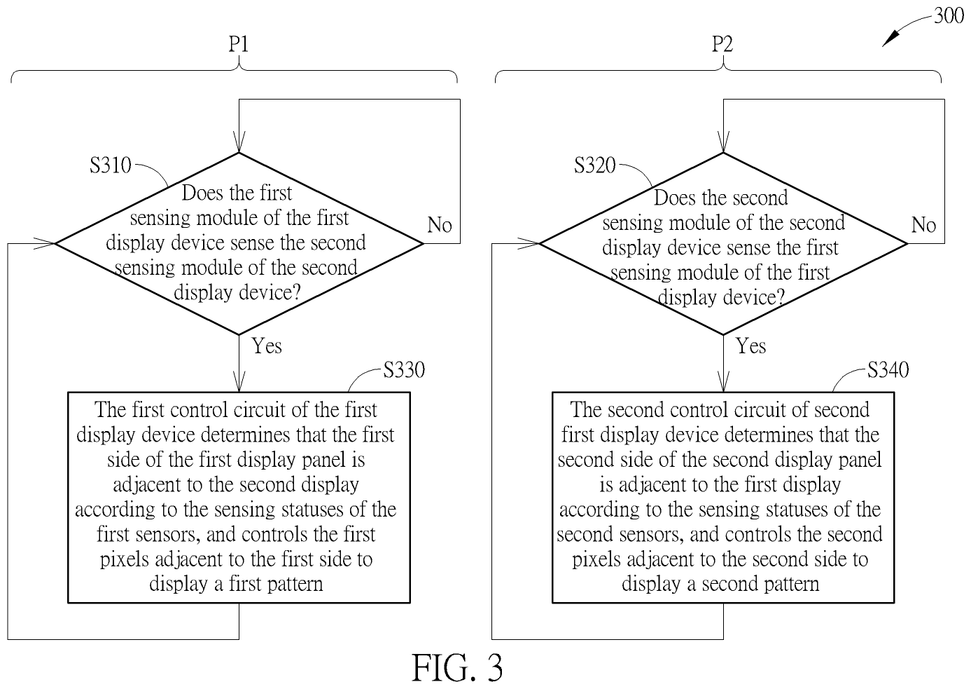

FIG. 3 is a flowchart of a method 300 for controlling the multi-screen splicing structure in FIG. 1 according to an embodiment of the invention. The method 300 comprises a first procedure P1 and a second procedure P2. The first procedure P1 is executed by the first display device 100A and the second procedure P2 is executed by the second display device 100B. Therefore, the first procedure P1 and the second procedure P2 can be performed in parallel. The first procedure P1 comprises steps S310 and S330, and the second procedure P2 comprises steps S320 and S340. For the first display device 100A, in step S310, the first control circuit 130A of the first display device 100A determines whether the first sensing module 120A senses the second sensing module 120B of the second display device 100B. Since the first control circuit 130A determines that the first sensing module 120A has sensed the second sensing module 120B of the second display device 100B, step S330 is executed. In step S330, the first control circuit 130A of the first display device 100A determines that the first side 124A of the first display panel 110A is adjacent to the second display device 100B according to the sensing states of the plurality of first sensors 122A, and controls the first portion of the first pixels 112A adjacent to the first side 124A to display the first pattern 160A. Similarly, for the second display device 100B, in step S320, the second control circuit 130B of the second display device 100B determines whether the second sensing module 120B senses the first sensing module 120A of the first display device 100A. Since the second control circuit 130B determines that the second sensing module 120B has sensed the first sensing module 120A of the first display device 100A, step S340 is executed. In step S340, the second control circuit 130B of the second display device 100B determines that the second side 124B of the second display panel 110B is adjacent to the first display device 100A according to the sensing states of the plurality of second sensors 122B, and controls the second portion of the second pixels 112B adjacent to the second side 124B to display the second pattern 160B.

In an embodiment of the present invention, when the first sensing module 120A no longer senses the second sensing module 120B, the first control circuit 130A controls the first portion of the first pixels 112A adjacent to the first side 124A to continue displaying the first pattern 160A. Similarly, when the second sensing module 120B no longer senses the first sensing module 120A, the second control circuit 130B controls the second portion of the second pixels 112B adjacent to the second side 124B to continue displaying the second pattern 160B. In this way, when the first display device 100A and the second display device 100B are temporarily separated, the user can be directed to rejoin the first side 124A of the first display device 100A with the second side 124B of the second display device 100B according to the first pattern 160A and second pattern 160B.

In another embodiment of the present invention, when the first sensing module 120A no longer senses the second sensing module 120B, the first control circuit 130A controls the first portion of the first pixels 112A adjacent to the first side 124A to stop displaying the first pattern 160A. Similarly, when the second sensing module 120B no longer senses the first sensing module 120A, the second control circuit 130B controls the second portion of the second pixels 112B adjacent to the second side 124B to stop displaying the second pattern 160B.

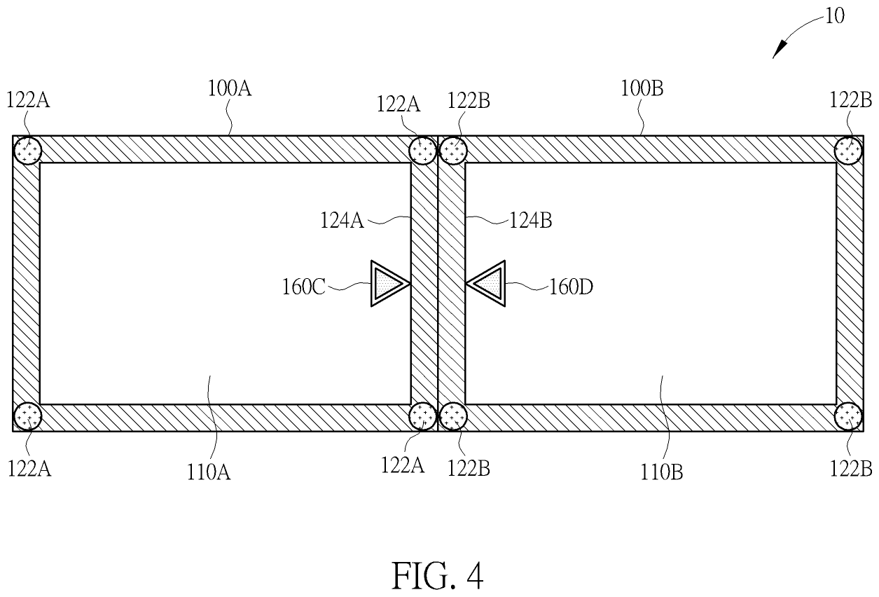

FIG. 4 is another schematic diagram of the first display device 100A and the second display device 100B of the multi-screen splicing structure 10 in FIG. 1. In an embodiment of the present invention, the first display device 100A further comprises a first wireless communications module 140A, and the second display device 100B further comprises a second wireless communications module 140B. When the first wireless communications module 140A and the second wireless communications module 140B are wirelessly connected, the first control circuit 130A controls the first portion of the first pixels 112A adjacent to the first side 124A to display a third pattern 160C, and the second control circuit 130B controls the second portion of the second pixels 112B adjacent to the second side 124B to display a fourth pattern 160D. The third pattern 160C is different from the first pattern 160A, and the fourth pattern 160D is different from the second pattern 160B. Taking FIGS. 2 and 4 as examples, the first pattern 160A and the second pattern 160A are triangles respectively, and each of the third pattern 160C and the fourth pattern 160D contains two triangles of different sizes, which are a big triangle and a small triangle enclosed by the big triangle. In addition, the first pattern 160A is displayed by the first portion of the first pixels 112A adjacent to the first side 124A when the first wireless communications module 140A and the second wireless communications module 140B are not wirelessly connected, and the second pattern 160D is displayed by the second portion of the second pixels 112B adjacent to the second side 124B when the first wireless communications module 140A and the second wireless communications module 140B are not wirelessly connected. With the first pattern 160A, the second pattern 160B, the third pattern 160C, and the fourth pattern 160D, the user can identify whether the first wireless communications module 140A and the second wireless communications module 140B are successfully wirelessly connected.

In an embodiment of the present invention, the first display panel 110A and the second display panel 110B may be touch panels. When the first pattern 160A is touched, the first control circuit 130A controls the first wireless communications module 140A to wirelessly connect to or disconnect from the second wireless communications module 140B. In detail, when a wireless connection between the first wireless communications module 140A and the second wireless communications module 140B have been established, if the first pattern 160A is touched, the first control circuit 130A controls the first wireless communications module 140A to disconnect from the second wireless communications module 140B. Contrarily, when the first wireless communications module 140A and the second wireless communications module 140B are not wirelessly connected, if the first pattern 160A is touched, the first control circuit 130A controls the first wireless communications module 140A to wirelessly connect to the second wireless communications module 140B. Similarly, for the second display device 100B, when the wireless connection between the first wireless communications module 140A and the second wireless communications module 140B have been established, if the second pattern 160B is touched, the second control circuit 130B controls the second wireless communications module 140B to disconnect from the first wireless communications module 140A. Contrarily, when the first wireless communications module 140A and the second wireless communications module 140B are not wirelessly connected, if the second pattern 160B is touched, the second control circuit 130B controls the second wireless communications module 140B to wirelessly connect to the first wireless communications module 140A.

In another embodiment of the present invention, when the first control circuit 130A determines that the first display panel 110A is adjacent to the second display panel 110B, the first control circuit 130A would trigger the first wireless communications module 140A to wirelessly connect with the second wireless communications module 140B. Similarly, when the second control circuit 130B determines that the second display panel 110B is adjacent to the first display panel 110A, the second control circuit 130B would trigger the second wireless communications module 140B to wirelessly connect with the first wireless communications module 140A.

In addition, in an embodiment of the present invention, when the first pattern 160A is touched, the first control circuit 130A would send a file 142A to the second wireless communications module 140B through the first wireless communications module 140A, and the second display device 100B would open the file 142A. Similarly, when the second pattern 160B is touched, the second control circuit 130B would send a file 142B to the first wireless communications module 140A through the second wireless communications module 140B, and the first display device 100A would open the file 142B.

In another embodiment of the present invention, when the first pattern 160A is touched, the first control circuit 130A would send an image displayed by the first display panel 110A to the second wireless communications module 140B through the first wireless communications module 140A, and the display panel 110B would display the image received by the second wireless communications module 140B. Similarly, when the second pattern 160B is touched, the second control circuit 130B would send an image displayed by the second display panel 110B to the first wireless communications module 140A through the second wireless communications module 140B, and the first display panel 110A would display the image received by the first wireless communications module 140A.

In an embodiment of the present invention, when the first wireless communications module 140A and the second wireless communications module 140B are wirelessly connected, and when the first sensing module 120A no longer senses the second sensing module 120B, the first control circuit 130A controls the first portion of the first pixels 112A adjacent to the first side 124A to continue displaying the first pattern 160A, and the second control circuit 130B controls the second portion of the second pixels 112B adjacent to the second side 124B to continue displaying the second pattern 160B. In another embodiment of the present invention, when the first wireless communications module 140A and the second wireless communications module 140B are not wirelessly connected, and when the first sensing module 120A no longer senses the second sensing module 120B, the first control circuit 130A controls the first portion of the first pixels 112A adjacent to the first side 124A to stop displaying the first pattern 160A, and the second control circuit 130B controls the second portion of the second pixels 112B adjacent to the second side 124B to stop displaying the second pattern 160B.

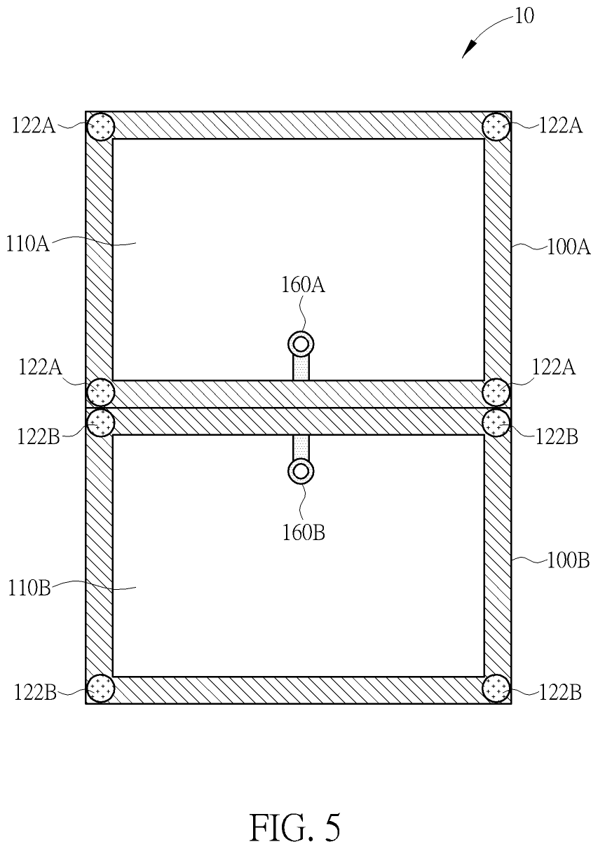

Moreover, as shown in FIGS. 2 and 4, since the first display device 100A and the second display device 100B of the multi-screen splicing structure 10 are adjacent to each other with their shorter sides, the first display device 100A and the second display device 100B are suitable for displaying images in a landscape mode. In contrast, if the first display device 100A and the second display device 100B are adjacent to each other with their longer sides, it is suitable for displaying images in a portrait mode. FIG. 5 is another schematic diagram of the first display device 100A and the second display device 100B of the multi-screen splicing structure 10 in FIG. 1. The first display device 100A and the second display device 100B are adjacent to each other with their longer sides. In addition, the first pattern 160A and the second pattern 160B shown in FIG. 5 are specific and symmetrical patterns, which are different from the first pattern 160A and the second pattern 160B that are triangular in FIG. 2.

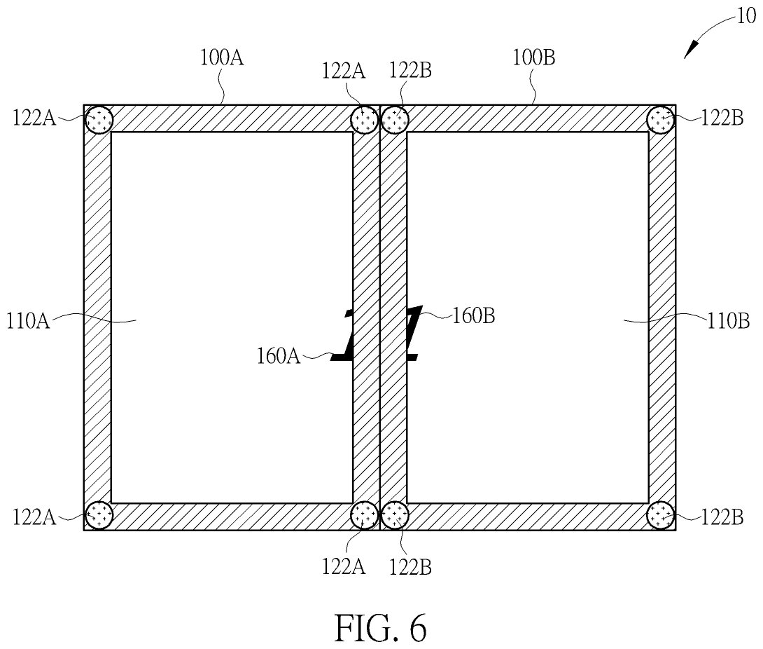

In another embodiment of the present invention, the first pattern 160A and the second pattern 160B may form a pattern of an Arabic numeral. For example, the first pattern 160A and the second pattern 160B in FIG. 6 may form an Arabic numeral “1”.

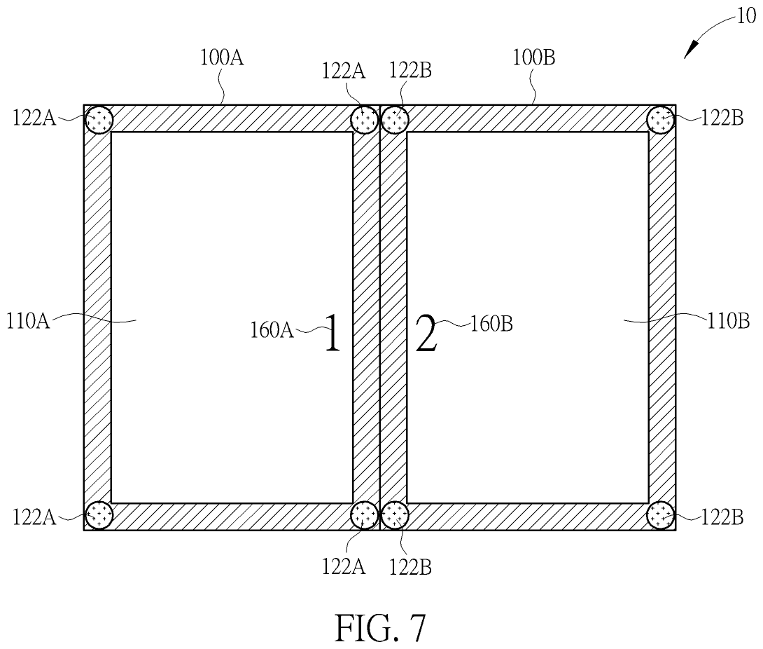

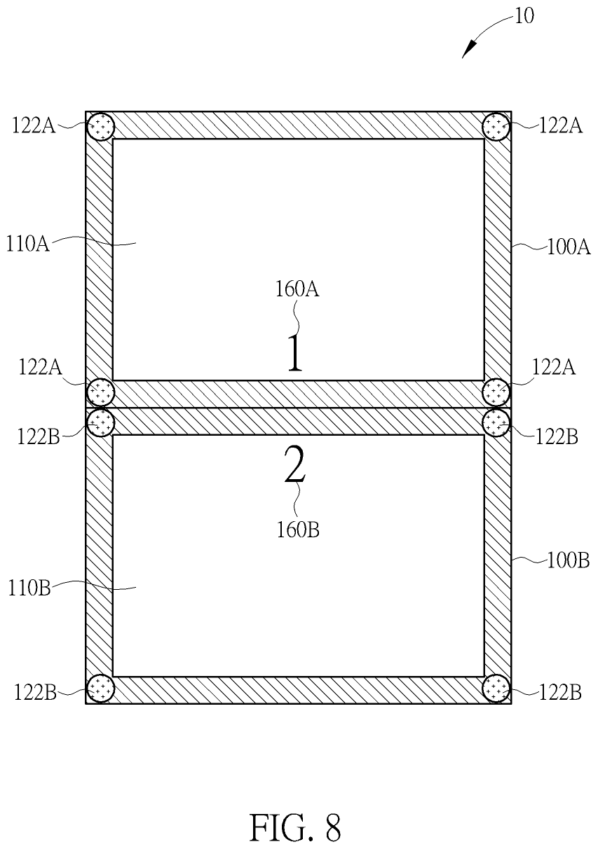

In another embodiment of the present invention, each of the first pattern 160A and the second pattern 160B may be a pattern of an Arabic numeral. For example, the first pattern 160A and the second pattern 160B in FIGS. 7 and 8 are patterns of Arabic numerals “1” and “2” respectively.

In another embodiment of the present invention, the first display device 100A further comprises a first gravity sensor (G sensor) 150A, and the second display device 100B further comprises a second gravity sensor 150B. The first control circuit 130A may determine whether the first display panel 110A is in an upright position, a horizontal position, a flat position or other setting positions according to an output signal of the first gravity sensor 150A, and control the first display panel 110A to display the first pattern 160A according to the setting position of the first display panel 110A. For example, when the multi-screen splicing structure 10 in the landscape mode (as shown in FIG. 7) is rotated 90 degrees to operate in the portrait mode (as shown in FIG. 8), the first pattern 160A shown in FIG. 7 would also be rotated 90 degrees as shown in FIG. 8. Similarly, the second control circuit 130B may determine whether the second display panel 110B is in an upright position, a horizontal position, a flat position or other setting positions according to an output signal of the second gravity sensor 150B, and control the second display panel 110B to display the second pattern 160B according to the setting position of the second display panel 110B.

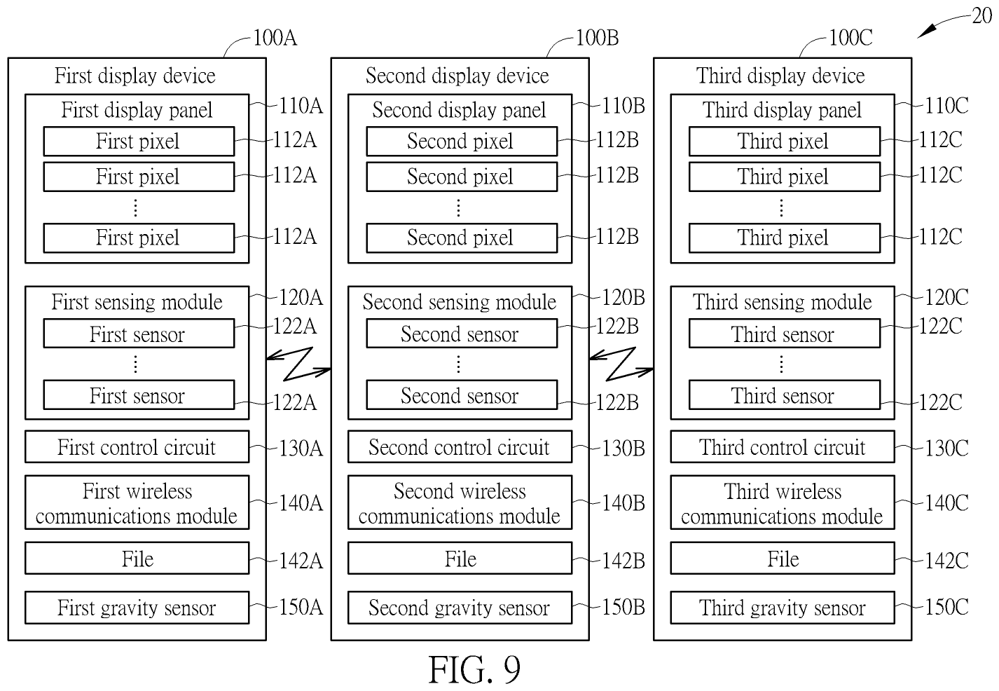

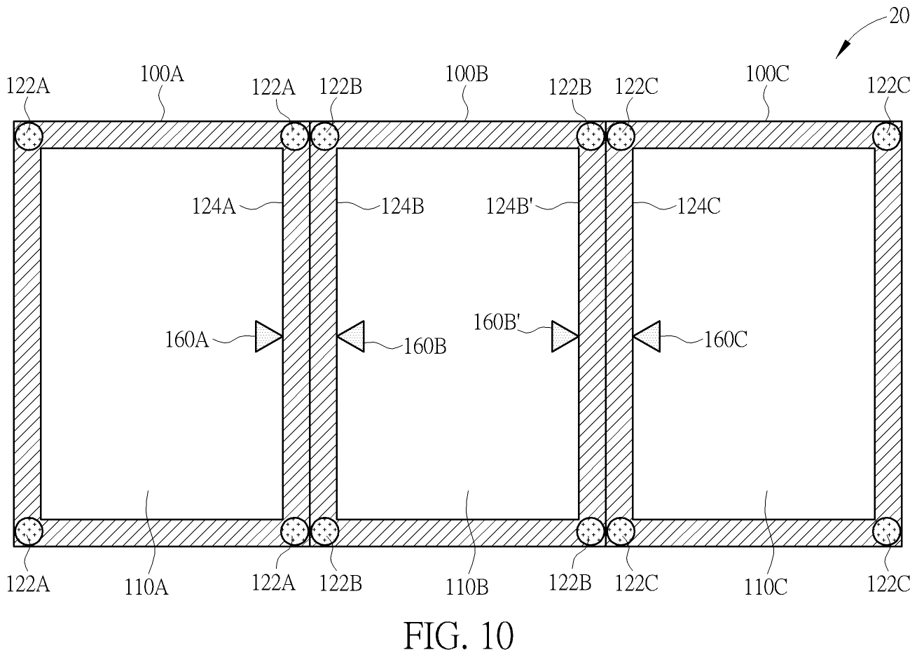

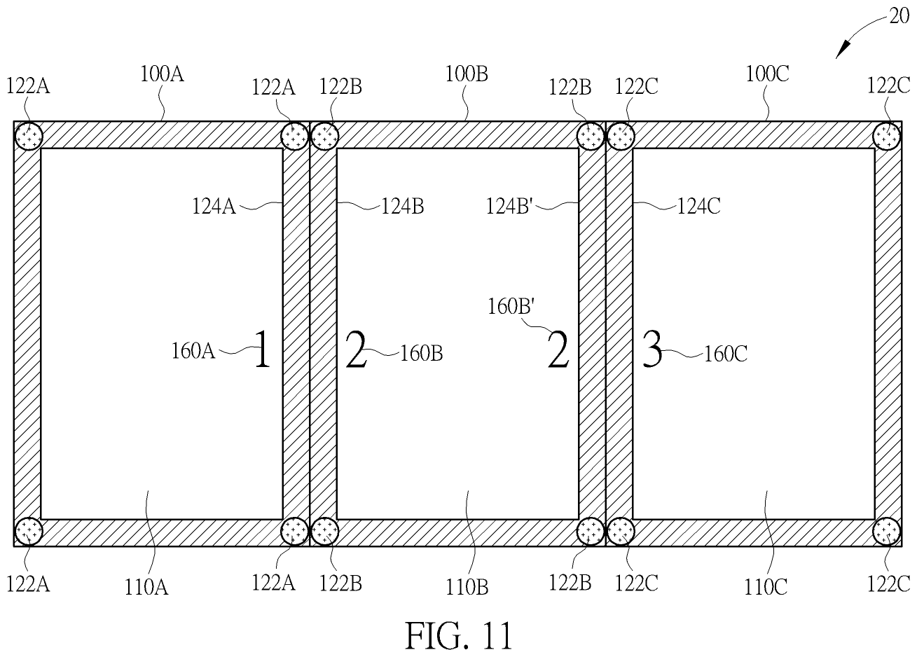

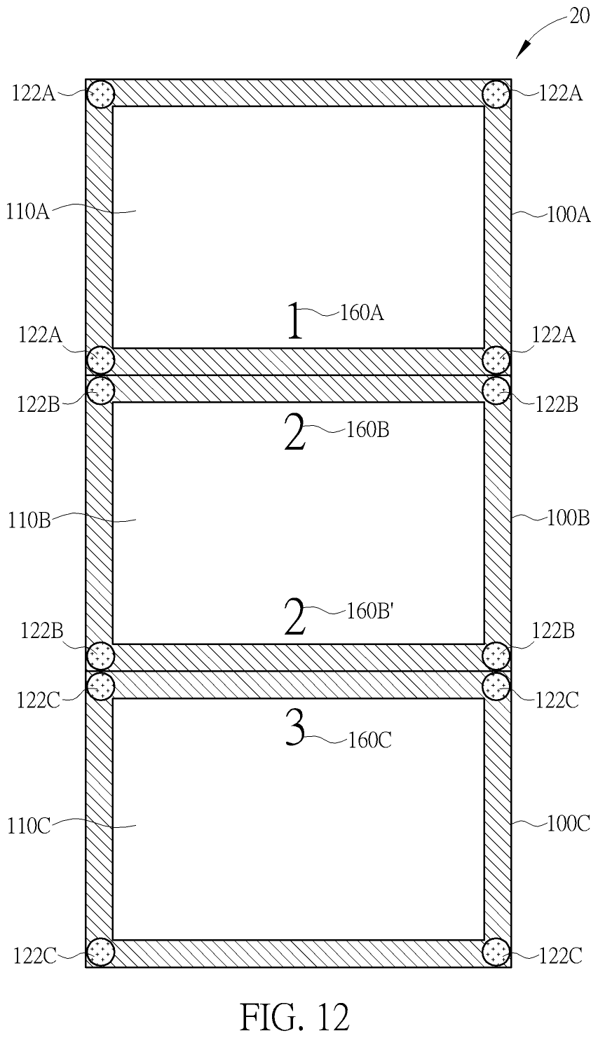

FIG. 9 is a functional block diagram of a multi-screen splicing structure 20 according to another embodiment of the present invention, and FIGS. 10 to 12 are schematic diagrams of the multi-screen splicing structure 20 in FIG. 9. The main difference between the multi-screen splicing structure 20 in FIG. 9 and the multi-screen splicing structure 10 in FIG. 1 is that the multi-screen splicing structure 20 further comprises a third display device 100C. The third display device 100C comprises a third display panel 110C, a third sensing module 120C, and a third control circuit 130C. The third display panel 110C comprises a plurality of third pixels 112C for displaying images. The third sensing module 120C comprises a plurality of third sensors 122C, which are respectively arranged around the third display panel 110C and can mutually sense with the first sensors 122A or the second sensors 122B. The third control circuit 130C is coupled to the third display panel 110C and the third sensing module 120C, and is configured to control the operations of the third display device 100C. Based on the sensing states of the third sensors 122C, the third control circuit 130C is capable of determining which side of the third display panel 110C is adjacent to other displays. When the third sensing module 120C senses the second sensing module 120B, the third control circuit 130C determines that a third side 124C of the third display panel 110C is adjacent to the second display device 100B according to sensing states of the third sensors 122C, and controls a third portion of the third pixels 112A adjacent to the third side 124C to display a third pattern 160C. Similarly, when the second sensing module 120B senses the third sensing module 120C, the second control circuit 130B determines that a fourth side 124B′ of the second display panel 110B is adjacent to the third display device 100C according to the sensing states of the second sensors 122B, and controls a fourth portion of the second pixels 112B adjacent to the fourth side 124B′ to display a fourth pattern 160B′. The second side 124B and the fourth side 124B′ are opposite sides of the second display panel 110B. The third pattern 160C and the fourth pattern 160B′ may be symmetrical patterns. For example, in FIG. 10, the third pattern 160C and the fourth pattern 160B′ are two symmetrical triangles. In addition, the first pattern 160A, the second pattern 160B, and the third pattern 160C can be consecutive Arabic numeral patterns, as shown in FIGS. 11 and 12.

In an embodiment of the present invention, the third display device 100C may further comprise a third wireless communications module 140C, whose operation principle and method are similar to those of the first wireless communications module 140A and the second wireless communications module 140B (e.g., the third control circuit 130C would send a file 142C to the first wireless communications module 140A and/or the second wireless communications module 140B through the third wireless communications module 140C), so it will not be repeated here. In addition, in an embodiment of the present invention, the third display device 100C may further comprise a third gravity sensor 150C, and its operation principle and method are similar to those of the first gravity sensor 150A and the second gravity sensor 150B, so it will not be repeated.

In summary, when the control circuit detects the proximity of another display device according to the sensors of the sensing module, the pixels of the display panel adjacent to the other display device would display a corresponding pattern. Accordingly, the user may splice the display devices of the multi-screen splicing structure (e.g., a splicing sequence, wireless connection states, etc.) according to the patterns displayed on the display panels of the multi-screen splicing structure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a multi-screen splicing structure, the multi-screen splicing structure comprising:
a first display device, comprising:
a first display panel comprising a plurality of first pixels;
a first sensing module comprising a plurality of first sensors respectively disposed around the first display panel; and
a first control circuit coupled to the first display panel and the first sensing module; and
a second display device, comprising:
a second display panel comprising a plurality of second pixels;
a second sensing module comprising a plurality of second sensors respectively disposed around the second display panel; and
a second control circuit coupled to the second display panel and the second sensing module;
the method comprising:
when the first sensing module senses the second sensing module, the first control circuit determining that a first side of the first display panel is adjacent to the second display device and controlling a first portion of the first pixels adjacent to the first side to display a first pattern; and
when the second sensing module senses the first sensing module, the second control circuit determining that a second side of the second display panel is adjacent to the first display device and controlling a second portion of the second pixels adjacent to the second side to display a second pattern.

2. The method of claim 1, wherein the first pattern and the second pattern are symmetrical to each other.

3. The method of claim 1, wherein the first pattern and the second pattern form a pattern of an Arabic numeral.

4. The method of claim 1, further comprising:
when the first sensing module no longer senses the second sensing module, the first control circuit controlling the first portion of the first pixels adjacent to the first side to continue displaying the first pattern; and
when the second sensing module no longer senses the first sensing module, the second control circuit controlling the second portion of the second pixels adjacent to the second side to continue displaying the second pattern.

5. The method of claim 1, further comprising:
when the first sensing module no longer senses the second sensing module, the first control circuit controlling the first portion of the first pixels adjacent to the first side to stop displaying the first pattern; and
when the second sensing module no longer senses the first sensing module, the second control circuit controlling the second portion of the second pixels adjacent to the second side to stop displaying the second pattern.

6. The method of claim 1, wherein the first display device further comprises a first wireless communications module, the second display device further comprises a second wireless communications module, and the method further comprises:
when the first wireless communications module and the second wireless communications module are wirelessly connected, the first control circuit controlling the first portion of the first pixels adjacent to the first side to display a third pattern, and the second control circuit controlling the second portion of the second pixels adjacent to the second side to display a fourth pattern;
wherein the first pattern is displayed by the first portion of the first pixels adjacent to the first side when the first wireless communications module and the second wireless communications module are not wirelessly connected, and the second pattern is displayed by the second portion of the second pixels adjacent to the second side when the first wireless communications module and the second wireless communications module are not wirelessly connected; and
wherein the third pattern is different from the first pattern, and the fourth pattern is different from the second pattern.

7. The method of claim 1, wherein the first display panel is a touch panel, the first display device further comprises a first wireless communications module, the second display device further comprises a second wireless communications module, and the method further comprises:
when the first pattern is touched, the first control circuit controlling the first wireless communications module to wirelessly connect to or disconnect from the second wireless communications module.

8. The method of claim 1, wherein the first display panel is a touch panel, the first display device further comprises a first wireless communications module, the second display device further comprises a second wireless communications module, and the method further comprises:
when the first pattern is touched, the first control circuit sending a file to the second wireless communications module through the first wireless communications module, and the second display device opening the file.

9. The method of claim 1, wherein the first display panel is a touch panel, the first display device further comprises a first wireless communications module, the second display device further comprises a second wireless communications module, and the method further comprises:
when the first pattern is touched, the first control circuit sending an image to the second wireless communications module through the first wireless communications module, and the second display panel displaying the image.

10. The method of claim 1, wherein the first display panel is a touch panel, the first display device further comprises a first wireless communications module, the second display device further comprises a second wireless communications module, and the method further comprises:
when the first control circuit determines that the first display panel is adjacent to the second display panel, the first control circuit enabling the first wireless communications module to wirelessly connect with the second wireless communications module.

11. The method of claim 10, wherein when the first wireless communications module and the second wireless communications module are wirelessly connected and the first sensing module no longer senses the second sensing module, the first control circuit controls the first portion of the first pixels adjacent to the first side to continue displaying the first pattern.

12. The method of claim 11, wherein when the first wireless communications module and the second wireless communications module are not wirelessly connected and the first sensing module no longer senses the second sensing module, the first control circuit controls the first portion of the first pixels adjacent to the first side to stop displaying the first pattern.

13. The method of claim 1, wherein the multi-screen splicing structure further comprises:
a third display device comprising:
a third display panel comprising a plurality of third pixels;
a third sensing module comprising a plurality of third sensors respectively disposed around the third display panel; and
a third control circuit coupled to the third display panel and the third sensing module; and
the method further comprises:
when the third sensing module senses the second sensing module, the third control circuit determining that a third side of the third display panel is adjacent to the second display device and controlling a third portion of the third pixels adjacent to the third side to display a third pattern; and
when the second sensing module senses the third sensing module, the second control circuit determining that a fourth side of the second display panel is adjacent to the third display device and controlling a fourth portion of the second pixels adjacent to the fourth side to display a fourth pattern.

14. The method of claim 13, wherein the first pattern, the second pattern, and the third pattern are consecutive Arabic numeral patterns.
